(19) United States
(12) Patent Application Publication
(10) Pub. No.: US 2026/0235930 A1
(43) Pub. Date: Aug. 13, 2026

(54) BIRD ACTIVITY PHOTOGRAPHING SYSTEM AND METHOD

(71) Applicant: Netvue Technologies Co., Ltd., Shenzhen (CN)

(72) Inventor: Chuan Chen, Shenzhen (CN)

(21) Appl. No.: 19/053,396

(22) Filed: Feb. 13, 2025

(51) Int. Cl. G03B 15/00; A01K 31/12; A01K 39/012; A01K 39/02; A01K 45/00; G03B 37/02

(52) U.S. Cl. CPC G03B 15/00; A01K 31/12; A01K 39/012; A01K 39/0206; A01K 45/002; G03B 37/02

(57) ABSTRACT

A bird activity photographing system includes a bird activity mechanism and at least one camera; wherein the bird activity mechanism is used for birds to perform bird activity; the camera captures 360-degree photographing of bird activity in at least one dimension to acquire a 360-degree bird activity image. Accordingly, the application also discloses a bird activity photographing method applied to the above-mentioned bird activity photographing system of the application, including the steps of: S1: providing at least one camera for photographing bird activity on a bird activity mechanism; S2: performing 360-degree photographing of bird activity in at least one dimension using at least one of the cameras to acquire a 360-degree bird activity image.

### TECHNICAL FIELD

The application relates to the technical field of animal activity image acquisition, particularly to a bird activity photographing system and method.

### BACKGROUND

With the continuous progress of photography technology and the improvement of people's demand for natural environment observation, bird activity photography has gradually become a hot field. Traditional bird photographing methods mainly rely on the patience and skills of photographers, as well as in-depth understanding of bird habits. However, this method is not only time consuming and labor intensive, but also difficult to capture the full details of bird activity.

At present, some devices related to the photographing of bird activity have appeared on the market. However, current devices on the market have a relatively simple and narrow viewing angle for birds, etc. cannot achieve a larger range of photographing, are difficult to capture more scenes and details of bird activity, and users cannot watch more, greatly reducing the user's viewing experience.

### SUMMARY

The technical problem to be solved by the application is: the application discloses a bird activity photographing system and method, so as to solve the problems that the existing bird photographing system has a relatively single and narrow viewing angle for birds, etc. cannot achieve a larger range of photographing, and is difficult to capture more scenes and details of bird activity.

In order to solve the above-mentioned technical problem, the technical solution adopted by the application is: a bird activity photographing system including: a bird activity mechanism and at least one camera; wherein the bird activity mechanism is used for birds to perform bird activity; the camera captures 360-degree photographing of bird activity in at least one dimension to acquire a 360-degree bird activity image.

The problem of carrying out panoramic photographing to bird's activity effectively to prior art. In the above-mentioned technical solution of the application, the application discloses a bird activity photographing system, including a bird activity mechanism and at least one camera, which attracts birds to stay through the bird activity mechanism, and at least one camera is provided to photograph bird activity, the camera captures 360-degree photographing of bird activity in at least one dimension, aiming to photograph and record various bird activities of birds on the bird activity mechanism from a 360-degree panoramic view angle, thereby enabling a wider and more comprehensive photographing record.

Further, in the bird activity photographing system described in the application, the number of the cameras is one, the camera rotates by a preset angle range around its own position and performs 360-degree photographing of bird activity in at least one dimension.

In the above-mentioned technical solution of the application, in order to facilitate the application, when the camera is actually provided, a camera may be provided, and the camera is provided with a corresponding rotation preset angle range so as to enable the camera to perform 360-degree photographing of bird activity in at least one dimension, thereby ensuring low cost and at the same time providing relatively comprehensive image recording.

It should be noted that, in the 360-degree photographing performed by rotating the single camera within the preset angle range, the finally obtained 360-degree bird activity image is obtained by cutting and splicing the bird activity images of a plurality of different time frames.

Further, in the bird activity photographing system described in the application, the number of the cameras is one, the camera is provided at a top end or a bottom end of the bird activity mechanism and photographs upward or downward in a vertical direction to perform 360-degree photographing of bird activity in at least one dimension.

In the above-mentioned technical solution of the application, the camera is provided at the top end or the bottom end of the bird activity mechanism, and in the process of practical application, the above-mentioned camera can be specifically selected as a fish-eye camera, wherein the fish-eye camera has a wider photographing range, and can also realize 360-degree photographing of bird activity when one camera is provided.

Further, in the bird activity photographing system described in the application, the number of the cameras is a plurality, a plurality of the cameras are provided next to or opposite to each other to respectively photograph bird activity images of a preset range; wherein in the sum of the preset ranges of the plurality of cameras, 360-degree photographing of bird activity in at least one dimension can be performed.

Further, in the bird activity photographing system described in the application, the bird activity images photographed by a plurality of the cameras are cut and spliced to form a 360-degree bird activity image in at least one dimension.

In the above-mentioned technical solution of the application, each camera photographs a bird activity image in a preset range, and in the sum of the preset ranges of the above-mentioned plurality of cameras, 360-degree photographing of bird activity in at least one dimension can be performed, thereby realizing 360-degree photographing of bird activity by the plurality of cameras. In addition, it should be noted that since each camera only photographs a preset range of activity images, for the purpose of final observation, the preset range of bird activity images photographed by each camera can be cut and spliced to obtain the required 360-degree bird activity images.

Further, in the bird activity photographing system described in the application, the cameras are two and each is fish-eye cameras, and the two fish-eye cameras are provided back to back.

Further, in the bird activity photographing system described in the application, the number of the cameras is at least three, and three of the cameras are provided next to or opposite to each other in the same dimension.

In the above-mentioned technical solution of the application, the number of the above-mentioned cameras can be specifically selected as two or three. In the case where the number of cameras is two, two fish-eye cameras provided back-to-back may be provided to perform 360-degree photographing by the two fish-eye cameras. Also, in the case where the number of cameras is three, the three cameras are provided next to or opposite to each other in the same dimension to perform 360-degree photographing of bird activity in at least one dimension.

Further, in the bird activity photographing system described in the application, the plurality of cameras are fixedly provided if the plurality of cameras are fixedly provided and in the sum of the preset ranges for photographing, 360-degree photographing in at least one dimension can be performed; if the plurality of cameras are fixedly provided and cannot perform 360-degree photographing in at least one dimension, at least one of the cameras needs to rotate a preset angle around its own position to complete the photographing.

Further, in the bird activity photographing system described in the application, the bird activity mechanism may specifically be at least one of a bird grain feeder, a hummingbird food feeder, a bird bath, or a bird stand rack.

In the above-mentioned technical solution of the application, the bird activity mechanism is a multifunctional activity mechanism, which can achieve multiple functions, such as feeding and water feeding, etc. to birds, and thus can effectively attract birds to stay on the bird activity mechanism, increase the probability of birds staying, and facilitate a camera to capture and record birds.

Further, in the bird activity photographing system described in the application, the bird grain feeder includes: feeding plates and grain feeding bodies; the feeding plate is provided at a lower end of the grain feeding body, a through grain bin is provided inside the grain feeding body, and a lower end of the grain bin is a grain discharging end and is in communication with the feeding plate; wherein the camera is provided on the outer peripheral surface of the grain feeding body, and the direction of the feeding plate is photographed from inside to outside; alternatively, the camera is provided at the periphery of the feeding plate, and the direction of the feeding plate is photographed from outside to inside.

Further, in the bird activity photographing system described in the application, the bird grain feeder includes: feeding plates and grain feeding bodies; the grain feeding body is provided below the feeding plate, a through grain bin is provided inside the grain feeding body, and an upper end of the grain bin is a grain discharging end and is in communication with the feeding plate; wherein the camera is provided at the top of the feeding plate, and the direction of the feeding plate is photographed from inside to outside; alternatively, the camera is provided at the periphery of the feeding plate, and the direction of the feeding plate is photographed from outside to inside.

Further, in the bird activity photographing system described in the application, the bird grain feeder includes: feeding plates and grain feeding bodies;
the feeding plate is provided at a lower end of the grain feeding body, and the camera is provided on an outer peripheral surface of the grain feeding body or above the feeding plate, and the direction of the feeding plate is photographed from inside to outside; or the camera is provided at the periphery of the feeding plate to photograph from the outside to the inside;
alternatively, the grain feeding body is provided below the feeding plate, the camera is provided at the top of the feeding plate, and the direction of the feeding plate is photographed from inside to outside; alternatively, the camera is provided at the outer periphery of the feeding plate to photograph from outside to inside.

In the above-mentioned technical solution of the application, in order to facilitate feeding birds via a bird grain feeder, when actually provided, a feeding plate and a grain bin may be provided in the bird grain feeder, and a grain conveying channel may be provided between the feeding plate and the grain bin, and grain may be conveyed from the storage grain bin to a feeding trough via the grain conveying channel, and after the grain in the feeding trough is consumed, the grain may be supplemented via the grain conveying channel, thereby achieving convenient feeding of birds.

Further, in the bird activity photographing system described in the application, a stand rack is further included, and the stand rack is connected to the outer periphery of the feeding plate.

In the above-mentioned technical solution of the application, a corresponding stand rack can be provided at the periphery of the feeding plate to provide a standing position required by birds when eating, so that the birds can stand on the stand rack when eating, and the use effect of the bird grain feeder can be improved.

Further, in the bird activity photographing system described in the application, the hummingbird food feeder includes: the sucking component and the hummingbird feeding body; the lower end of the hummingbird feeding body is connected to the sucking component, at least one sucking port is provided on the sucking component, and the camera is provided on the hummingbird feeding body or on the top of the sucking component.

Further, in the bird activity photographing system described in the application, the hummingbird food feeder includes: a hummingbird feeding body, at least one extension component and at least one sucking component, wherein one end of the extension component is connected to the hummingbird feeding body and the other end of the extension component is connected to the sucking component, and the sucking component is extended to the periphery of the hummingbird feeding body, and
the sucking component is located at or above the top of the hummingbird feeding body, and the camera is provided on the top of the hummingbird feeding body;
alternatively, the sucking component is located in the middle of the hummingbird feeding body, and the camera is provided on the periphery surface of the hummingbird feeding body;
alternatively, the sucking component is located at or below the bottom of the hummingbird feeding body, and the camera is provided at the periphery surface of the hummingbird feeding body.

Further, in the bird activity photographing system described in the application, the bird bath includes: a bath body; wherein the camera is provided on the top of the bath body, or above, or on the periphery of the bath body.

Further, in the bird activity photographing system described in the application, the bird stand rack includes: a main support and a secondary support rod, the main support extending in a first direction and the secondary support rod extending in a second direction, one end of the secondary support rod being connected to the main support; wherein the camera is provided on at least one of the main support or the secondary support rod.

Further, in the bird activity photographing system described in the application, the camera is provided at an outer periphery of the main support to photograph from inside to outside; alternatively, the camera is provided at the other end of the secondary support rod or at the outer periphery of the secondary support rod to photograph from outside to inside.

In the above-mentioned technical solution of the application, the bird stand rack includes a main support and a secondary support rod, wherein the main support can be used for placing a video camera so as to perform 360 panoramic photographing for bird activities from inside to outside, and the secondary support rod can be used for hanging a bird grain feeder, a hummingbird food feeder, a bird bath, etc. so as to hang and support the bird grain feeder, the hummingbird food feeder, the bird bath, etc.

Further, in the bird activity photographing system described in the application, the bird activity photographing system further includes a rotating rod and a surround photographing camera; the surround photographing camera is provided at one end of the rotating rod, and the other end of the rotating rod is rotatably connected to the main support and rotates about the main support as a rotating shaft.

In the above-mentioned technical solution of the application, since the rotating rod is rotatably provided on the main support, the surround photographing camera can flexibly adjust the photographing angle within a certain range as required under the support of the main support so as to perform close-up photographing on the corresponding bird activity, thereby better capturing the bird activity.

Further, in the bird activity photographing system described in the application, at least one close-up camera is provided on the main support, and the close-up camera is rotatably provided on the main support and rotates about the main support as a rotating shaft.

Further, in the bird activity photographing system described in the application, the bird stand rack further includes a lifting assembly that lifts and lowers at least one of the camera, the surround photographing camera, or the close-up camera along the first direction.

Accordingly, another object of the application is to disclose a bird activity photographing method which can be applied to the above-mentioned bird activity photographing system of the application, and which specifically includes the steps of:
S1: providing at least one camera for photographing bird activity on a bird activity mechanism;
S2: performing 360-degree photographing of bird activity in at least one dimension using at least one of the cameras to acquire a 360-degree bird activity image.

The beneficial effects of the application are: the application provides a bird activity photographing system intended to capture and record various bird activities of birds on a bird activity mechanism from a 360-degree panoramic view angle. In this application, the bird activity photographing system includes a bird activity mechanism and at least one camera, wherein the bird activity mechanism can be used to attract a bird to stay, thereby allowing the bird to perform various bird activities on the bird activity mechanism, such as foraging, drinking, inhabiting, bathing, etc. On this basis, the corresponding camera is provided, and the bird activity is performed 360-degree photographing in at least one dimension by the camera, no matter which position of the bird activity in that dimension, it can be photographed by at least one camera, so as to achieve a wider and more comprehensive photographing record for the bird activity, greatly improving the use effect, and having a good promotion prospect and application value.

### BRIEF DESCRIPTION OF THE DRAWINGS

FIG. 1 is a schematic structural view of a bird activity photographing system described in the application in an embodiment from a next view angle;

FIG. 2 is a schematic structural view of the bird activity photographing system described in the application in an embodiment from an another view angle;

FIG. 3 is a schematic structural view of a bird grain feeder of the bird activity photographing system described in the application in an embodiment from the next view angle;

FIG. 4 is a front view of a bird grain feeder of the bird activity photographing system described in the application in an embodiment;

FIG. 5 is a schematic view of a-a section of the bird grain feeder shown in FIG. 4;

FIG. 6 is a schematic structural view of the bird grain feeder of the bird activity photographing system described in the application in another embodiment;

FIG. 7 is a schematic structural view of a bird bath of the bird activity photographing system described in the application in an embodiment in a next view angle;

FIG. 8 is a schematic structural view of a hummingbird food feeder of the bird activity photographing system described in the application in an embodiment;

FIG. 9 is a schematic structural view of a hummingbird food feeder of the bird activity photographing system described in the application in another embodiment;

FIG. 10 is a schematic structural view of a hummingbird food feeder of the bird activity photographing system described in the application in yet another embodiment;

FIG. 11 is a schematic structural view of a hummingbird food feeder of the bird activity photographing system described in the application in still another embodiment;

FIG. 12 is a schematic structural view of two cameras photographing from inside to outside of the bird activity photographing system described in the application;

FIG. 13 is a schematic structural view of three cameras photographing from inside to outside of the bird activity photographing system described in the application;

FIG. 14 is a schematic structural view of in four cameras photographing from inside to outside of the bird activity photographing system described in the application;

FIG. 15 is a schematic structural view of a plurality of cameras photographing from the outside to the inside of the bird activity photographing system described in the application; and

FIG. 16 is a flowchart of the steps of the bird activity photographing system described in the application in an embodiment.

### DESCRIPTION OF REFERENCE NUMERALS

1. camera;
2. bird stand rack; 21. main support; 22. secondary support rod;
3. bird grain feeder; 31. feeding plate; 32. feeding body; 33. grain bin; 34. grain conveying channel; 35. food trough; 36. stand rack;
4. hummingbird food feeder; 41. sucking component; 42. hummingbird feeding body; 43. connector; 44. sucking port;
5. bird bath; 51. bath body; 52. platform; 53. water pump;
6. bird cage;
7. rotating rod;
8. surround photographing camera;
9. close-up camera.

### DETAILED DESCRIPTION OF THE EMBODIMENTS

In order to explain the technical contents, the objects, and the effects of the application in detail, the embodiments will be described below with reference to the accompanying drawings.

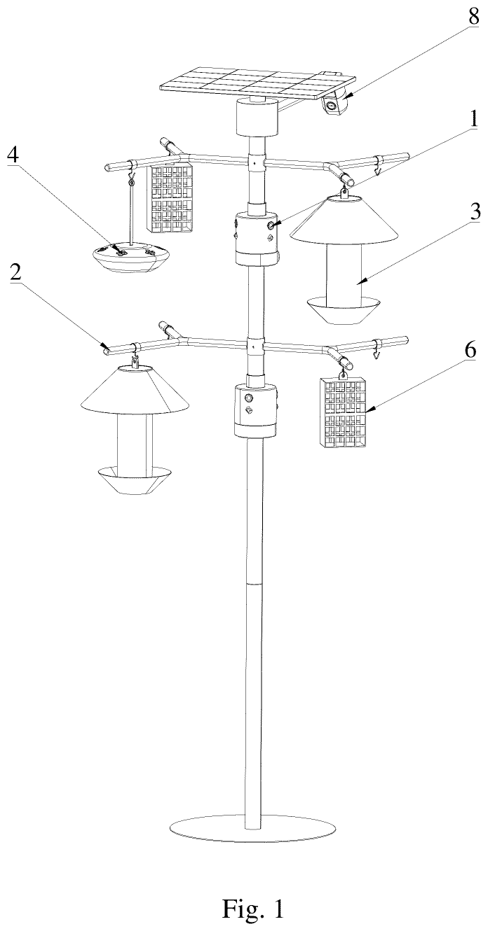

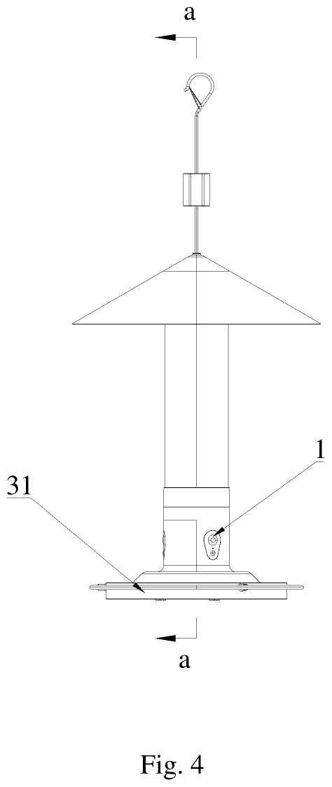

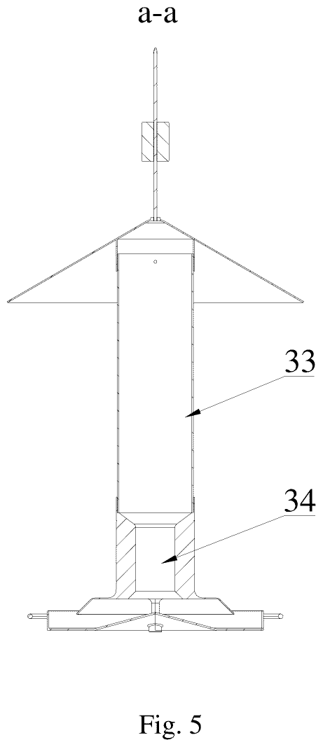

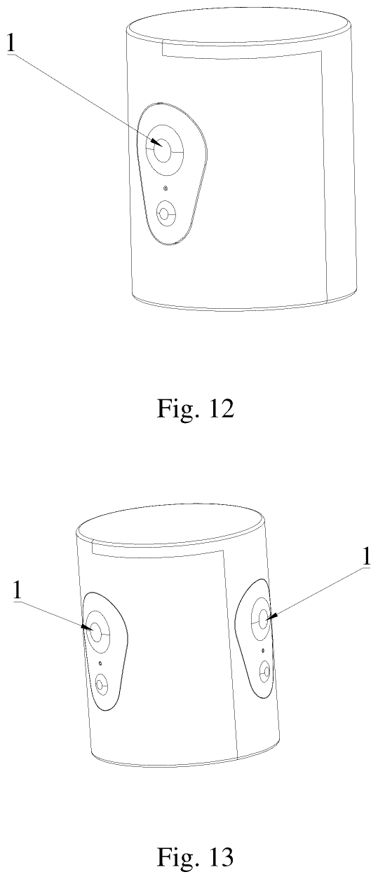

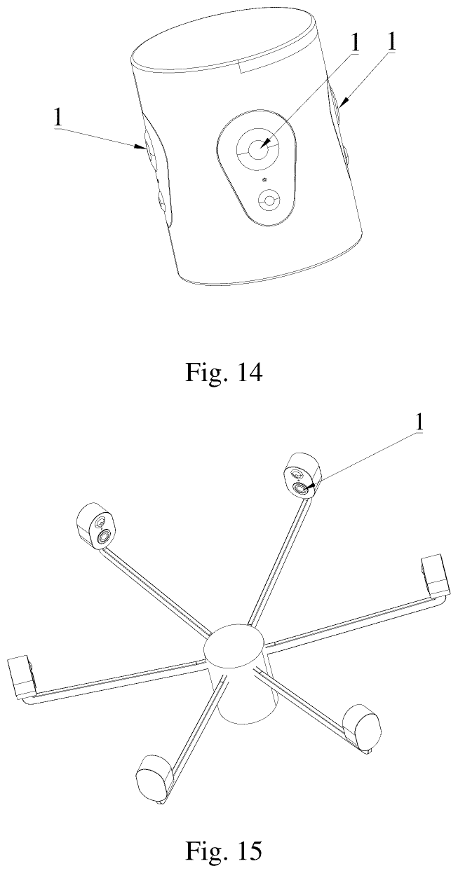

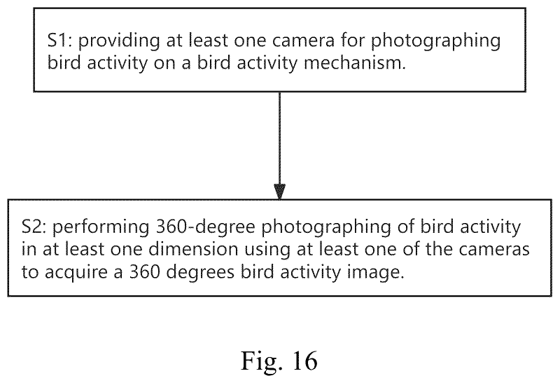

Referring to FIGS. 1-16, in the present embodiment, the application discloses a bird activity photographing system comprises: a bird activity mechanism and at least one camera 1; the bird activity mechanism is used for birds to perform bird activity; the camera 1 is used for performing 360-degree photographing of bird activity in at least one dimension to acquire a 360-degree bird activity image. The bird activity photographing system can be specifically used to implement the following bird activity photographing method, which specifically includes the steps of:
S1: providing at least one camera 1 for photographing bird activity on a bird activity mechanism;
S2: performing 360-degree photographing of bird activity in at least one dimension using at least one camera 1 to acquire a 360-degree bird activity image.

Based on the above description, when the bird activity photographing system is actually applied, the bird activity mechanism can be used to attract a bird to stay, thereby allowing the bird to perform various bird activities on the bird activity mechanism, such as foraging, drinking, inhabiting, bathing, etc. On this basis, a corresponding camera 1 is provided, and the bird activity is performed 360-degree photographing in at least one dimension by the camera 1, no matter which position of the bird activity in that dimension, it can be photographed by at least one camera 1, so as to achieve a wider and more comprehensive photographing record for the bird activity, greatly improving the use effect.

Wherein the 360-degree bird activity image can be a bird activity image taken under a single time frame; it may also be a bird activity image taken at different time frames, such as a bird activity image taken within a short continuous time frame. Further, the 360-degree photographing may be a 360-degree panoramic photographing, and the 360-degree bird activity image may be a 360-degree panoramic bird activity image. The bird activity is performed 360-degree photographing in at least one dimension, which may be in a horizontal dimension, a vertical dimension, a circumferential dimension, a spherical surface, a hemispherical surface, a toroidal surface, a periphery surface, a top surface, a bottom surface, etc.

It can be seen from the above description that the existing bird photographing system has a relatively simple and narrow viewing angle for birds, etc. cannot achieve a larger range of photographing, and is difficult to capture more scenes and details of bird activity. The application provides a bird activity photographing system and method intended to capture and photograph various bird activities of birds on a bird activity mechanism in a 360-degree photographing range. In the application, at least one camera 1 is provided for photographing bird activity on a bird activity mechanism; and at least one camera 1 is used to perform 360-degree photographing for bird activity in at least one dimension to obtain a 360-degree bird activity image, which can be photographed by the at least one camera 1 regardless of the bird activity in which position in the dimension, so as to achieve a wider and more comprehensive photographing record for bird activity, greatly improving the use effect.

It should be noted that when the number of cameras 1 is provided as one, a preset angle range can be rotated around the position where the cameras 1 are located, so as to perform 360-degree photographing of bird activity in at least one dimension and obtain 360-degree bird activity images. The 360-degree bird activity images include bird activity images taken by the camera 1 at a plurality of different time frames.

In certain other examples, when the number of cameras 1 is provided as one, the cameras 1 may also be provided at the top or bottom of the bird activity mechanism and photographs in the vertical direction up or down to perform 360-degree photographing of bird activity in at least one dimension to acquire a 360-degree bird activity image. Among them, the 360-degree bird activity image is a bird activity image photographed by the camera 1 under a single time frame.

It can be seen from the above-mentioned description that when a camera 1 is provided, if the camera 1 is fixedly mounted, the camera 1 can be provided at the top end or the bottom end of the bird activity mechanism and photographs upward or downward in a vertical direction so as to perform 360-degree photographing of bird activity in a horizontal dimension perpendicular to the vertical direction. If the camera 1 is not provided at the top or bottom end of the bird activity mechanism, for example, provided in the middle, the camera 1 can be rotated around its own position by a preset angle range, photographing range can be increased by rotating, and a 360-degree bird activity image can be acquired, so that the 360-degree photographing of bird activity in at least one dimension can be performed. For example, when the camera 1 is provided to rotate a preset angle around the periphery surface of the bird activity mechanism, a 360-degree circumferential surround photographing can be performed from the inside to the outside of the periphery surface of the bird activity mechanism.

Further, in other embodiments, when the number of cameras 1 is provided as two, the two cameras 1 may be provided next to (e.g. back-to-back) or opposite to each other, and respectively photograph bird activity images of a preset range, in the sum of the preset ranges of two cameras, 360-degree photographing of bird activity in at least one dimension can be performed. The above-mentioned camera 1 can be specifically selected as a fish-eye camera, and two fish-eye cameras are provided back to back.

If the two cameras 1 are fixedly provided and in the sum of the preset ranges for photographing, 360-degree photographing in at least one dimension can be performed, the two cameras 1 are preferably fixedly provided. If two cameras 1 are fixedly provided and cannot perform 360-degree photographing in at least one dimension, at least one camera 1 needs to rotate a preset angle around its own position to complete the photographing.

Further, the bird activity images acquired by the two cameras 1 may be cut and spliced to form a 360-degree bird activity image in at least one dimension, i.e. a 360-degree continuous and non-overlapping bird activity image in at least one dimension.

It can be seen from the above description that in the case where two cameras 1 are provided, the two cameras 1 are provided back to back or opposite to each other, and respectively photograph bird activity images in a preset range. Then, the bird activity images acquired by the two cameras 1 are cut and spliced, so that a 360-degree bird activity image can be spliced in at least one dimension, thereby achieving panoramic photographing of bird activity in at least one dimension.

Accordingly, in still other embodiments, when the number of cameras 1 is provided to at least three, at least three cameras 1 may be provided on the same dimension next to or opposite to each other so as to respectively photograph bird activity images of a preset range, and in the sum of the preset ranges of at least three cameras 1, 360-degree photographing of bird activity in at least one dimension can be performed.

If three cameras 1 are fixedly provided and in the sum of the preset ranges for photographing, 360-degree photographing in at least one dimension can be performed, three cameras 1 are preferably fixedly provided. If three cameras 1 are fixedly provided and cannot perform 360-degree photographing in at least one dimension, at least one camera 1 needs to rotate a preset angle around its own position to complete the photographing. Namely, the plurality of cameras 1 are preferably fixedly provided, when a plurality of cameras are fixedly provided and in the sum of preset ranges for photographing, 360-degree photographing in at least one dimension can be performed; when a plurality of cameras 1 are fixedly provided and cannot perform 360-degree photographing in at least one dimension, at least one camera 1 needs to rotate a preset angle around its own position to complete the photographing, and the remaining cameras are still provided in a fixed provision.

Further, the bird activity images acquired by the at least three cameras 1 may be cut and spliced to form a 360-degree bird activity image in at least one dimension to form a 360 degree continuous and non-overlapping bird activity image in at least one dimension.

On the basis of this, in the case where at least three cameras 1 are provided, at least three cameras 1 may be provided on the same dimension next to or opposite to each other to respectively photograph bird activity images of a preset range. Then, the bird activity images acquired by the at least three cameras 1 are cut and spliced to form a 360-degree bird activity image in at least one dimension, thereby achieving panoramic photographing of bird activity in at least one dimension.

It can be seen from the above that when the bird activity photographing system is actually applied, the number and installation mode of the cameras 1 used by the bird activity photographing system can be selected according to actual situations, and one camera 1 and a plurality (two or more) of cameras 1 can be specifically selected, and if the camera fixed provision can perform 360-degree photographing, the fixed provision can be given priority; in addition, when the fixed provision cannot be satisfied, at least one camera 1 needs to rotate a preset angle around its own position to complete the photographing, which can both acquire and finally obtain a 360-degree bird activity image in at least one dimension, realize a larger range of photographing and capture more scenes and details of bird activity, thereby improving the user's observation experience.

It should be noted that, in practical applications, the camera 1 in the bird activity photographing system designed in the application can photograph from inside to outside or from outside to inside; for example, the providing next to each other is an inside-outside photographing, and providing opposite to each other is an outside-inside photographing. As shown in FIGS. 12, 13 and 14, a plurality of cameras 1 may be provided on the main support to perform inside-outside photographing, and the plurality of cameras 1 may be provided spaced apart from each other in the same circumferential direction of the support, for example, two cameras 1 may be provided back-to-back. Accordingly, as shown in FIG. 15, a plurality of cameras 1 may be provided on the side supports extending outward from the middle support to perform outside-inside photographing.

Further, it should be noted that when arranging a plurality of cameras 1, since the photographing preset range set by a single camera 1 is limited, generally only one specific direction or area can be covered. Therefore, it is necessary to form a 360-degree bird activity image in at least one dimension by cutting and splicing the bird activity images photographed by a plurality of cameras 1 to form a larger monitoring range. In this way a full coverage of a larger area can be achieved in at least one dimension, reducing photographing blindness.

It should be emphasized that in the example, the bird activity mechanism can specifically be at least one of the bird grain feeder 3, the hummingbird food feeder 4, the bird bath 5 or the bird stand rack 2, and feeding, water feeding, bathing and staying operations for birds can be realized by means of the bird grain feeder 3, the hummingbird food feeder 4, the bird bath 5 or the bird stand rack 2. The bird activity mechanism will be described below with reference to the specific examples of FIGS. 1 to 11, respectively.

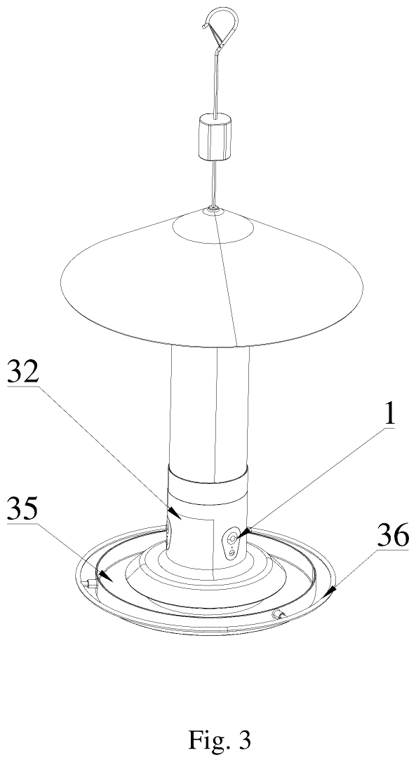

As shown in FIGS. 3 to 6, in the example, in order to attract birds close to the bird activity mechanism, to facilitate the camera 1 to photograph birds eating, and to obtain bird activity images of birds eating, a bird grain feeder 3 is disclosed. The bird grain feeder 3 is generally provided with a feeding plate 31 carrying bird grain for birds to eat, and a grain feeding body 32 connected to the feeding plate 31, supporting or suspending the feeding plate 31, and mounting the feeding plate 31 at a desired position.

In order to supplement the bird grain, the grain feeding body 32 is further provided with a grain bin 33 for storing the bird grain and supplementing the feeding plate 31 with the bird grain. When the grain feeding body 32 is provided with the grain bin 33, there are two ways of discharging grain downward and discharging grain upward according to the direction in which the grain bin 33 conveys the grain. When discharging grain downward, the lower end of the grain bin 33 is a grain discharging end, and the feeding plate 31 is installed at the lower end of the grain bin 33 to receive bird grain; when discharging grain upward, the upper end of the grain bin 33 is the grain discharging end, and the feeding plate 31 is installed at the top end of the grain bin 33 to receive the bird grain. The number and the setting position of the camera 1 are correspondingly provided corresponding to different grain discharging modes. When the plurality of cameras 1 are provided next to each other, the plurality of cameras 1 may be provided on the outer periphery of the grain feeding body 42 to photograph from the inside to the outside. When the plurality of cameras 1 are provided opposite to each other, the plurality of cameras 1 may be provided around the outer periphery of the feeding plate 31 to photograph from outside to inside.

With particular reference to FIGS. 3, 4 and 5, the bird grain feeder 3 is a feeding method, including: a feeding plate 31 and a grain feeding body 32, wherein the feeding plate 31 is provided at the lower end of the grain feeding body 32. The grain feeding body 32 is internally provided with a through grain bin 33, and the lower end of the grain bin 33 is a grain discharging end and is in communication with the feeding plate 31. Bird grain may be delivered to the feeding plate 31 by self-weight falling. Of course, in certain preferred embodiments, the bird grain feeder 3 may also be provided with a grain transport mechanism to transport the bird grain from the grain bin 33 to the feeding plate 31 in a timed and quantitative manner, taking into account the timed and quantitative feeding of birds. A hanger, such as a hook, may be attached to the upper end of the feeding body 32 to enable suspended mounting of the bird grain feeder 3.

Wherein at least one camera 1 is provided on the grain feeding body 32, and the feeding plate 31 has a feeding trough 35 therein. A grain conveying channel 34 is provided in the grain bin 33, one end of the grain conveying channel 34 is in communication with the grain bin 33, and the other end of the grain conveying channel 34 is in communication with the feeding trough 35. Based on the feeding plate 31, the grain feeding body 32 and the grain bin 33 provided above, birds can be conveniently supplied with food to feed them. At the same time, the camera 1 is provided on the grain feeding body 32 to facilitate the corresponding photographing of bird activities for people to observe or study.

When the number of the cameras 1 is one, the cameras 1 are provided on the outer peripheral surface of the grain feeding body 32 to photograph the direction of the feeding plate 31 from the inside to the outside, and the cameras 1 can rotate around the peripheral surface of the grain feeding body 32 by a preset angle and move circumferentially around the grain feeding body 32 to perform a 360-degree surround photographing on the direction of the feeding plate 31.

When the number of the cameras 1 is plural, the cameras 1 may be distributed on the outer periphery surface of the grain feeding body 32 to photograph the feeding plate 31 from inside to outside. For example, the number of cameras 1 is two, and two cameras 1 are provided back to back. For example, the number of cameras 1 may be three or four or more, and may be evenly spaced on the outer periphery surface of the grain feeding body 32. If the plurality of cameras 1 are fixedly provided and in the sum of the preset ranges for photographing, 360-degree photographing of the feeding plate 31 can be performed, the plurality of cameras 1 are preferably fixedly provided, and further, may be provided on the same dimension or height of the outer periphery of the grain feeding body 32.

If the fixed provision of the plurality of cameras 1 cannot be satisfied, at least one of the cameras 1 needs to rotate around the periphery surface of the grain feeding body 32 by a preset angle to complete the photographing.

Of course, a plurality of cameras 1 may be distributed around the outer periphery of the feeding plate 31 to photograph from outside to inside. The bird activity images acquired by the plurality of cameras 1 can be cut and spliced to form a continuous and non-overlapping 360-degree bird activity image. Therefore, the image of the bird eating the bird grains on the feeding plate 31 can be photographed in 360-degree, and the image of the bird eating the bird grains on the feeding plate 31 can be photographed no matter where the birds eat the bird grains, and the images cannot be missed.

To facilitate feeding by birds, the example also provides a corresponding stand rack 36 in the bird grain feeder 3, which is peripherally connected to the feeding plate 31. Further, a stand rack 36 is provided around the outer periphery wall of the feeding plate 31. With the stand rack 36, birds can stand on the stand rack 36 while eating.

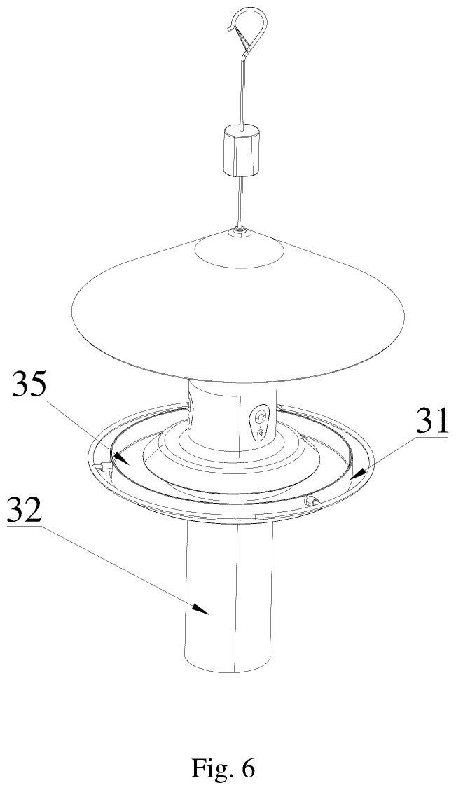

In addition, as shown in FIG. 6, the application also discloses another bird grain feeder 3, wherein the bird grain feeder 3 is an upper grain discharging manner, and the main structure of the bird grain feeder 3 is similar to the bird grain feeder 3 of FIGS. 3 to 5 above, but differs therefrom: the grain feeding body 32 of the bird grain feeder 3 shown in FIG. 6 is specifically provided below the feeding plate 31, and the upper end of the grain bin 33 is the grain discharging end. At this time, since the bird grain cannot be delivered to the feeding plate 31 by the self-weight falling manner, the grain feeding body 32 is further provided with a grain transporting mechanism for transporting the grain of the grain bin 33 to the feeding plate 31 from the bottom to the top in an upper grain discharging manner, thereby facilitating the bird to eat. The grain transport mechanism may be pneumatically or mechanically driven to push the bird grain from the bottom to the top, thereby pushing the bird grain out of the upper end of the barn 33 and onto the feeding plate 31 for consumption by birds.

In the bird grain feeder 3 shown in FIG. 6, in which the feeding plate 31 is placed on the top of the feeding plate 31 and is an area of bird activity, by placing one or more cameras 1 on the top of the feeding plate 31, the bird feeding process on the feeding plate 31 is performed 360-degree photographing, and corresponding images of bird activity at 360-degree are obtained, thereby forming a larger monitoring range.

In the embodiment, when the number of cameras 1 is one, the cameras 1 are provided on the top of the feeding plate 31, and the area of the feeding plate 31 can be photographed from the bottom up, or photographed from the inside out. When the area of the feeding plate 31 is photographed from bottom to top, the camera 1 can perform 360-degree photographing of bird activity in at least one dimension above, and therefore the camera 1 can be fixedly provided; when the area of the feeding plate 31 is photographed from the inside to the outside, the camera 1 needs to rotate a preset angle around its installation position to perform 360-degree surround photographing on the direction of the feeding plate 31, so as to perform 360-degree photographing on bird activities.

When the number of the cameras 1 is more than one, the cameras 1 may be provided next to each other on the top of the feeding plate 31 to photograph the feeding plate 31 from inside to outside. For example, the number of cameras 1 is two, two cameras 1 are provided back to back, and a fish-eye camera 1 may be employed. For example, the number of cameras 1 is three or four or more, and the circumferential distribution can be performed at an average interval. If the plurality of cameras 1 are fixedly provided and in the sum of the preset ranges for photographing, 360-degree photographing of the feeding plate 31 can be performed, the plurality of cameras 1 are preferably fixedly provided, and further, the plurality of cameras 1 may be respectively provided on the same dimension or height. If the fixed provisions of the plurality of cameras 1 cannot be satisfied, at least one of the cameras 1 needs to rotate a preset angle around its own installation position to complete the photographing. Of course, a plurality of cameras 1 may be distributed around the outer periphery of the feeding plate 31 to photograph from outside to inside. The bird activity images acquired by the plurality of cameras 1 can be cut and spliced to form a continuous and non-overlapping 360-degree bird activity image. Therefore, the image of the bird eating the bird grains on the feeding plate 31 can be photographed in 360-degree, and the image of the bird eating the bird grains on the feeding plate 31 can be photographed no matter where the birds eat the bird grains, and the images cannot be missed.

Further, in other ways, the bird grain feeder 3 may not be provided with a barn, which only includes: a feeding plate 31 and a grain feeding body 32. Here, the feeding plate 31 is used to carry the entire bird grain, and the grain feeding body 32 is used to support or hang the feeding plate 31. The feeding plate 31 may be provided at the lower end of the grain feeding body 32, and the camera 1 may be provided on the outer periphery surface of the grain feeding body 32 or above the feeding plate to photograph the direction of the feeding plate 31 from inside to outside, or the camera 1 may be provided on the outer periphery of the feeding plate 31 to photograph from outside to inside. Alternatively, the grain feeding body 32 may be provided below the feeding plate 31, and the camera 1 may be provided at the top of the feeding plate 31 to photograph the direction of the feeding plate 31 from inside to outside, or the camera 1 may be provided at the outer periphery of the feeding plate 31 to photograph the direction of the feeding plate 31 from outside to inside.

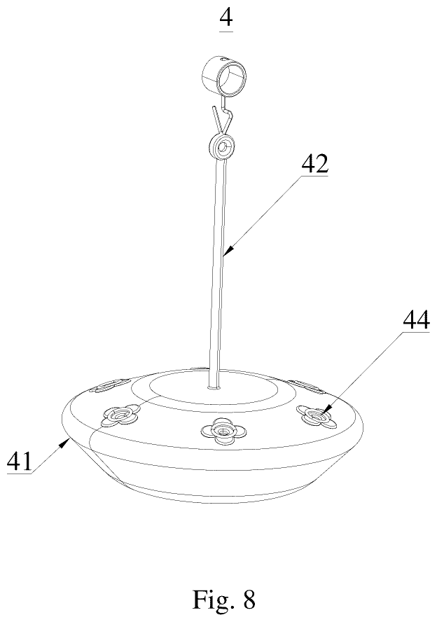

Accordingly, considering that some birds do not eating traditional cereal grains, for example: a hummingbird, the feeding process of the hummingbird is generally to select flowers in nature and eat nectar using a slender beak of the bee to achieve the purpose of eating; therefore, as shown in FIG. 8, in order to facilitate photographing when the hummingbird eats, FIG. 8 specifically discloses a structure of a hummingbird food feeder 4 to use the hummingbird food feeder 4 as a bird activity mechanism.

In the hummingbird food feeder 4 designed in FIG. 8, the sucking component 41 and a hummingbird feeding body 2 are included. The hummingbird feeding body 42 is connected with the sucking component 41 at the lower end, and can be connected to a hanging assembly such as a hook at the upper end. A water tank is connected below the sucking component 41, and at least one sucking port 44 is provided on the sucking component 41, and the sucking port 44 is in communication with the water tank, so that the beak of a bird extends into the water tank via the above-mentioned sucking port 44 and sucks sugar water correspondingly. Wherein the shape of the above-mentioned sucking port 44 can be set to be similar to a flower, and the shape of the sucking port 44 is provided to be a flower shape, so as to simulate the natural environment for a hummingbird to eat, so that the hummingbird is more likely to eat through the sucking port 44, thereby improving the use effect of the hummingbird food feeder 4.

When the hummingbird food feeder 4 of FIG. 8 is actually used, the camera 1 can be specifically provided on the hummingbird feeding body 42 or on the top of the sucking component 41, and the camera 1 can be used to perform 360-degree photographing of the hummingbird activity in at least one dimension, and a 360-degree panoramic photographing of the bird activity in at least one dimension can be achieved.

When the number of cameras 1 is one, the camera 1 can photograph the area of the sucking component 41 from the bottom up or from the inside out. When the area of the sucking component 41 is photographed from the bottom up, the camera 1 is provided at the top of the sucking component 41, and the camera 1 can perform 360-degree photographing of the hummingbird activity in at least one dimension above, so that the camera 1 can be fixedly provided. When the area of the sucking component 41 is photographed from the inside to the outside, the camera 1 is provided on the top of the sucking component 41 or on the peripheral surface of the feeding body 42, and the camera 1 needs to rotate around its installation position or the feeding body 42 by a preset angle to perform a 360-degree surround photographing on the area of the sucking component 41 so as to perform a 360-degree photographing on the hummingbird activity.

When the number of the cameras 1 is multiple, the area of the sucking component 41 can be photographed from inside to outside by being provided next to each other on the top of the sucking component 41 or on the periphery surface of the feeding body 42; for example: the number of cameras 1 is two, the two cameras 1 are provided back to back, and a fish-eye camera 1 can be used; for example: the number of the cameras 1 is three or four or more, and the circumferential distribution can be performed at an average interval.

If the plurality of cameras 1 are fixedly provided and in the sum of the preset ranges for photographing, 360-degree photographing of the sucking component 41 can be performed, the plurality of cameras 1 are preferably fixedly provided, and further, the plurality of cameras 1 may be respectively provided on the same dimension or height. If the fixed provisions of the plurality of cameras 1 cannot be satisfied, at least one of the cameras 1 needs to rotate a preset angle around its own installation position to complete the photographing.

Of course, a plurality of cameras 1 may also be distributed around the outer periphery of the sucking component 41 to photograph from outside to inside. The hummingbird activity images acquired by the plurality of cameras 1 can be cut and spliced to form a continuous and non-overlapping 360-degree bird activity image. Therefore, the image of the bird sucking the sugar water on the sucking component 41 can be photographed in 360-degree, and the image of the hummingbird sucking the sugar water on the sucking component 41 can be photographed no matter where the hummingbirds suck the sugar water, and the images cannot be missed.

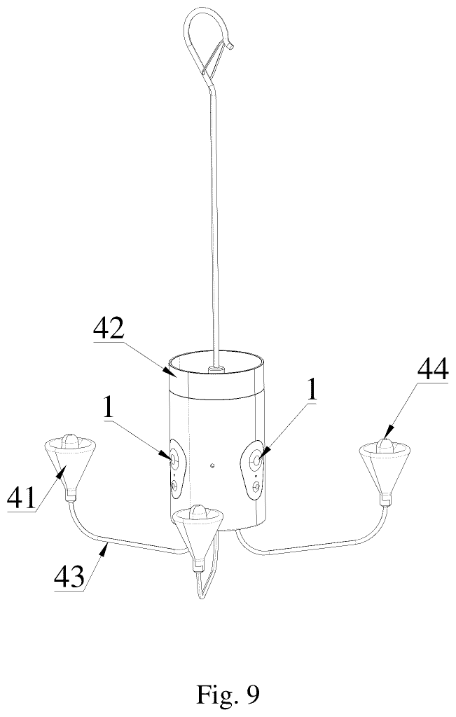

In addition, with further reference to FIGS. 9, 10 and 11, the application also discloses three other hummingbird food feeders 4, which are different from the hummingbird food feeders 4 shown in FIG. 8, and the hummingbird food feeders 4 of FIGS. 9, 10 and 11 all specifically include: the hummingbird feeding body 42, at least one extension component 43 and at least one sucking component 41. The extension component 43 is connected with the hummingbird feeding body 42 at one end and with the sucking component 41 at the other end, and extends the sucking component 41 to the periphery of the hummingbird feeding body 42. The camera 1 is provided on the hummingbird feeding body 42 for performing a 360-degree photographing when the hummingbird eats at the sucking port 44 of the sucking component 41. At this time, the camera 1 can determine the number and the installation position according to the positional relationship between the sucking component 41 and the hummingbird feeding body 42.

Here, the number of the cameras 1 may be one or more if the sucking component 41 is positioned on the top or above the hummingbird feeding body 42. When the number of cameras 1 is one, the cameras 1 can photograph the area above the top of the hummingbird feeding body 42 from the bottom up or the area of the sucking component 41 from the inside out. When photographing an area above the top of the hummingbird feeding body 42 from the bottom up, the camera 1 is provided on the top of the hummingbird feeding body 42, and the camera 1 can perform 360-degree photographing of the hummingbird activity in at least one dimension above, so that the camera 1 can be fixedly provided. When photographing the area of the sucking component 41 from the inside to the outside, the camera 1 is provided on the top of the hummingbird feeding body 42, and the camera 1 needs to rotate a preset angle around its installation position to perform a 360-degree surround photographing on the area of the sucking component 41 so as to perform a 360-degree photographing on the hummingbird activity.

When the number of cameras 1 is multiple, the cameras are provided next to each other on the top of the hummingbird feeding body 42 to photograph the area of the sucking component 41 from the inside to the outside. For example, the number of cameras 1 is two, two cameras 1 are provided back to back, and a fish-eye camera 1 may be employed. For example, the number of cameras 1 is three or four or more, and the circumferential distribution can be performed at an average interval. If the plurality of cameras 1 are fixedly provided and in the sum of the preset ranges for photographing, 360-degree photographing of the sucking component 41 can be performed, the plurality of cameras 1 are preferably fixedly provided, and further, the plurality of cameras 1 may be respectively provided on the same dimension or height. If the fixed provisions of the plurality of cameras 1 cannot be satisfied, at least one of the cameras 1 needs to rotate a preset angle around its own installation position to complete the photographing. Of course, a plurality of cameras 1 may also be distributed around the outer periphery of the sucking component 41 to photograph from outside to inside.

If the sucking component 41 is located in the middle of the hummingbird feeding body 42, the number of the cameras 1 is provided to be multiple, and distributed around the outer periphery of the feeding body 42, and the area of the sucking component 41 is photographed from inside to outside. For example, the number of cameras 1 is two, two cameras 1 are provided back to back, and a fish-eye camera 1 may be employed. For example, the number of cameras 1 is three or four or more, and the circumferential distribution can be performed at an average interval. If the plurality of cameras 1 are fixedly provided and in the sum of the preset ranges for photographing, 360-degree photographing of the sucking component 41 can be performed, the plurality of cameras 1 are preferably fixedly provided, and further, the plurality of cameras 1 may be respectively provided on the same dimension or height. If the fixed provision of the plurality of cameras 1 cannot be satisfied, at least one of the cameras 1 needs to rotate around its own installation position or the outer periphery of the hummingbird feeding body 42 by a preset angle to complete the photographing. Of course, a plurality of cameras 1 may also be distributed around the outer periphery of the sucking component 41 to photograph from outside to inside.

If the sucking component 41 is located at or below the bottom of the hummingbird feeding body 42, the number of the cameras 1 may be one or more. When the number of the cameras 1 is one, the cameras 1 can photograph the area under the bottom of the hummingbird feeding body 42 downward, or photograph the area of the sucking component 41 from the inside out. When photographing an area below the bottom of the hummingbird feeding body 42, the camera 1 is provided on the bottom of the hummingbird feeding body 42, and the camera 1 can perform 360-degree photographing of the hummingbird activity in at least one dimension below, so that the camera 1 can be fixedly provided. When photographing the area of the sucking component 41 from the inside to the outside, the camera 1 is provided on the bottom of the hummingbird feeding body 42, and the camera 1 needs to rotate a preset angle around its installation position to perform a 360-degree surround photographing on the area of the sucking component 41 so as to perform a 360-degree photographing on the hummingbird activity.

When the number of cameras 1 is multiple, the cameras are provided next to each other on the bottom of the hummingbird feeding body 42 to photograph the area of the sucking component 41 from the inside to the outside. For example, the number of cameras 1 is two, two cameras 1 are provided back to back, and a fish-eye camera 1 may be employed. For example, the number of cameras 1 is three or four or more, and the circumferential distribution can be performed at an average interval. If the plurality of cameras 1 are fixedly provided and in the sum of the preset ranges for photographing, 360-degree photographing of the sucking component 41 can be performed, the plurality of cameras 1 are preferably fixedly provided, and further, the plurality of cameras 1 may be respectively provided on the same dimension or height. If the fixed provisions of the plurality of cameras 1 cannot be satisfied, at least one of the cameras 1 needs to rotate a preset angle around its own installation position to complete the photographing. Of course, a plurality of cameras 1 may also be distributed around the outer periphery of the sucking component 41 to photograph from outside to inside.

It should be noted that in practical applications, in order to facilitate birds to drink water, the above-mentioned sucking component 41 further includes a water-hiding bag, and one end of the above-mentioned water-hiding bag is provided with a sucking port 44, so that the beak of the birds extends into the water-hiding bag via the sucking port 44 to eat; here, the above-mentioned water-hiding bag can independently store sugar water to supply hummingbirds to suck.

Of course, in the example, in order to reduce the frequency of adding sugar water to the user and reduce the burden on the user, a water tank is specifically provided in the hummingbird feeding body 42, and a water delivery channel is controlled to be provided in the extension component 43, and the water delivery channel is in communication with the water-hiding bag and the water tank, so that the water tank is used to store sugar water, and the sugar water is controlled to be fed into the sucking component 41 through the water delivery channel for the hummingbird to suck.

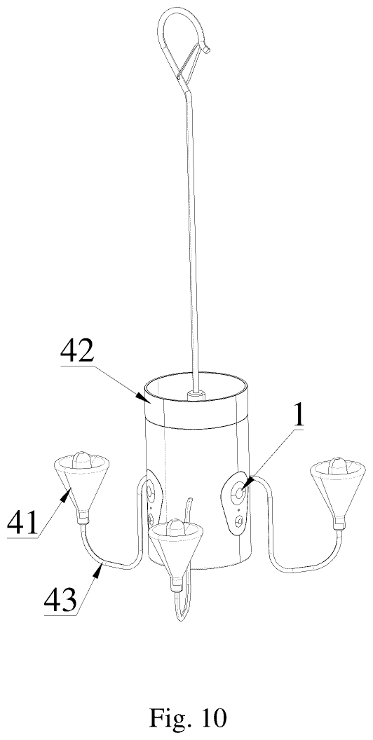

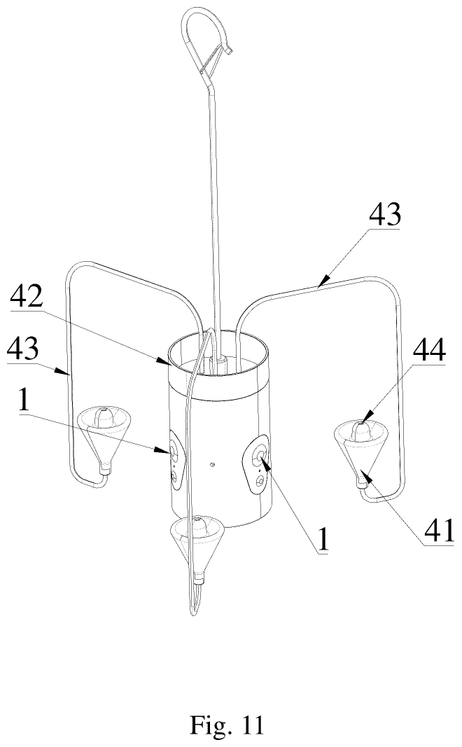

In practical use, one end of the extension component 43 of the hummingbird food feeder 4 shown in FIG. 9 communicates with the water tank from the bottom end of the feeding body 42; one end of the extension component 43 of the hummingbird food feeder 4 shown in FIG. 10 communicates with the water tank from the middle of the feeding body 42; one end of the extension component 43 of the hummingbird food feeder 4 shown in FIG. 11 communicates with the water tank from the top end of the feeding body 42. With regard to the above-mentioned different connection forms, different ways of driving the sugar water can be selected, and an electric driving mode or a non-power mode can be specifically selected to drive the sugar water from the water tank to enter the water-hiding bag of the sucking component 41 through the water delivery channel, so as to improve the use effect of the bee and bird grain feeder 4.

Accordingly, when photographing bird activity on the hummingbird food feeder 4 shown in FIG. 9, FIG. 10 and FIG. 11, the hummingbird food feeder 4 can be specifically photographed by providing three cameras 1 on the main body 42, and the three cameras 1 can be uniformly provided around the peripheral wall of the main body 42 to combine the activity images photographed by the three cameras 1 to photograph and obtain a 360-degree bird activity image of the hummingbird feeding activity.

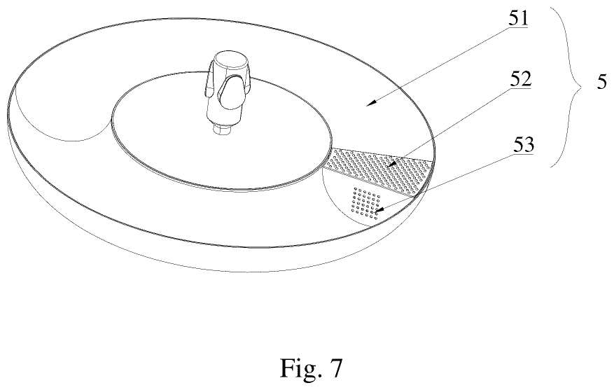

In addition, with further reference to FIG. 7, in the example, a corresponding bird bath 5 may also be provided to attract birds to monitor the bird activity image of the bird bath and drinking scene. In the example, as shown in FIG. 7, the bird bath 5 includes: A bath body 51 and a platform 52 and a water pump 53 provided in the bath body 51; here, at least one camera 1 is provided on the top or above the bath body 51.

It should be noted that when the bird bath 5 of the example shown in FIG. 7 is actually used, the bird bath 5 described above can be used not only for bird bath but also for bird drinking, i.e. the camera 1 used therein can also photograph a 360-degree bird activity image of bird drinking activity.

For a bird bath 5, the cameras 1 are placed on top of or above the bath body 51, and the number of cameras 1 may be one or more. When the number of cameras 1 is one, the cameras 1 can photograph the top or upper area of the bath body 51 from the bottom up, or photograph the area of the bath body 51 from the inside. When the top or upper area of the bath body 51 is photographed from the bottom up, the camera 1 can perform 360-degree photographing of bird activity in at least one dimension above, so the camera 1 can be fixedly provided. When the area of the bath body 51 is photographed from the inside to the outside, the camera 1 is provided on the top of the bath body 51, and the camera 1 needs to rotate a preset angle around its installation position to perform 360-degree surround photographing on the area of the bath body 51 so as to perform 360-degree photographing on bird activities.

When the number of cameras 1 is multiple, the cameras are provided next to each other on the top of the bath body 51 to photograph the area of the bath body 51 from the inside to the outside. For example, the number of cameras 1 is two, two cameras 1 are provided back to back, and a fish-eye camera 1 may be employed. For example, the number of cameras 1 is three or four or more, and the circumferential distribution can be performed at an average interval. If the plurality of cameras 1 are fixedly provided and in the sum of the preset ranges for photographing, 360-degree photographing of the bath body 51 can be performed, the plurality of cameras 1 are preferably fixedly provided, and further, the plurality of cameras 1 may be respectively provided on the same dimension or height. If the fixed provisions of the plurality of cameras 1 cannot be satisfied, at least one of the cameras 1 needs to rotate a preset angle around its own installation position to complete the photographing. Of course, a plurality of cameras 1 may also be distributed around the outer periphery of the bath body 51 to photograph from outside to inside.

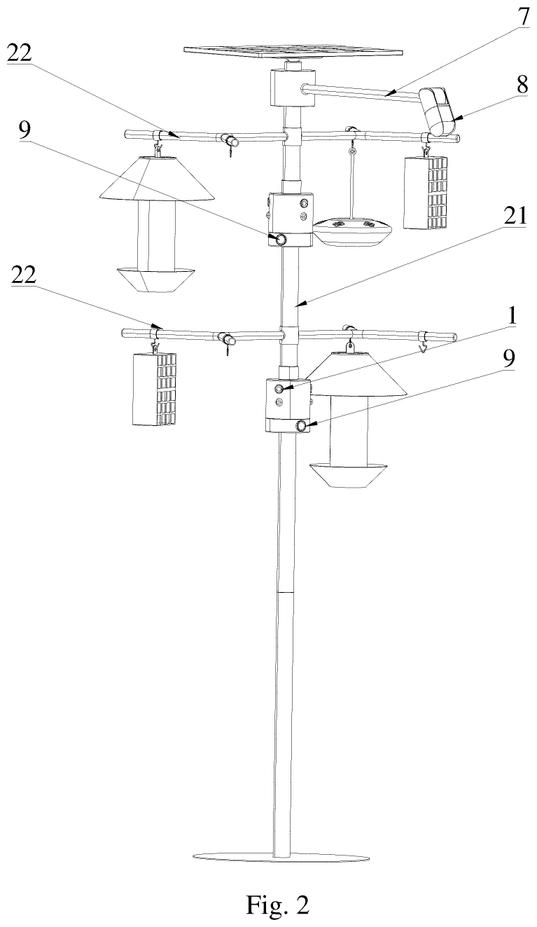

Further, referring to FIGS. 1 and 2, in the example, in order to provide a combination of the bird grain feeder 3, the hummingbird food feeder 4, the bird bath 5, and more bird activity mechanisms described above, so that a user can simultaneously observe a variety of bird activities, a corresponding bird stand rack 2 can be provided. As shown in FIG. 2, the bird stand rack 2 includes: a camera 1, a main support 21 and a secondary support rod 22, wherein the main support 21 extends in a first direction, the secondary support rod 22 extends in a second direction, and one end of the secondary support rod 22 is connected to the main support. Wherein the camera 1 is provided on at least one of a main support 21 or a secondary support rod 22, and the secondary support rod 22 is used for hanging at least one bird activity mechanism such as a bird grain feeder 3, a hummingbird food feeder 4 and a bird bath 5. It should also be noted that the first direction is a vertical height direction and the second direction is a horizontal direction. In addition, a corresponding bird cage 6 may be suspended from the bird stand rack for the birds to live.

In the preferred mode, the camera 1 is provided at the outer periphery of the main support 21 to photograph from inside to outside. When the number of cameras 1 is one, the cameras 1 can rotate around the peripheral surface of the main support 21 by a preset angle, move circumferentially around the main support 21, and perform 360 degree surround photographing on the outer periphery of the main support 21.

When the number of the cameras 1 is plural, the cameras 1 may be provided around the outer periphery of the main support 21 to photograph from inside to outside. For example, the number of cameras 1 is two, and two cameras 1 are provided back to back. For example, the number of cameras 1 is three or four or more, and may be evenly spaced around the outer periphery of the main support 21. If the plurality of cameras 1 are fixedly provided and the sum of the preset ranges for photographing is capable of performing 360-degree photographing on the periphery of the main support 21, the plurality of cameras 1 are preferably fixedly provided, and further may be provided on the same dimension or height of the outer periphery of the main support 21. If the fixed provision of the plurality of cameras 1 cannot be satisfied, at least one of the cameras 1 needs to rotate around the periphery of the main support 21 by a preset angle to complete the photographing. Of course, the plurality of cameras 1 may be provided at the other end of the secondary support rod 22 or at the outer periphery of the secondary support rod 22 so as to photograph from outside to inside. The bird activity images acquired by the plurality of cameras 1 can be cut and spliced to form a continuous and non-overlapping 360-degree bird activity image. Thus, various bird activity images of birds on the bird stand rack 2 can be photographed at 360-degree.

In order to facilitate better capture of bird activities, as shown in FIG. 2, the bird stand rack 2 in the example can also be provided with a rotating rod 7 and a surround photographing camera 8, wherein the surround photographing camera 8 is provided at one end of the rotating rod 7, and the other end of the rotating rod 7 is rotatably connected to the main support 21, and the main support 21 can rotate around an axis. Due to the rotatable connection of the rotating rod 7, so that the surround photographing camera 8 can perform a surrounding photographing on the bird stand rack 2, a tracking close-up photographing can be performed by rotating to any position according to the photographing requirements, or a surround photographing can be performed by rotating once, and a supplementary photographing can be performed by eliminating the possible occlusion of the camera 1 by some bird activity mechanisms on the bird stand rack 2, thereby better photographing and capturing the bird activity on the bird stand rack 2. In the example, the surround photographing camera 8 provided on the rotating rod 7 photographs images from the outside to the inside.

It should be noted that, as shown in FIG. 2, when the bird stand rack 2 is actually used, in order to provide a more abundant close-up view, close-up tracking is performed under different viewing angles. In the example, at least one close-up camera 9 is also correspondingly provided on the main support 21 of the bird stand rack 2. The close-up camera 9 is rotatably provided on the main support 21, and can rotate around the main support 21 as a rotating shaft to track and capture bird activities, and close-up photograph bird activities. The close-up camera 9 specifically photographs from the inside to the outside, that is, from a photographing angle toward the outside from the main support 21.

Still further, the bird stand rack 2 includes a lift assembly that can lift all of the cameras automatically or manually by the user. Specifically, at least one of the camera 1, the surround photographing camera 8 and the close-up camera 9 can be lifted and lowered in a first direction, namely, along a vertical height direction, so as to rationally set the photographing heights and positions of the camera 1, the surround photographing camera 8 and the close-up camera 9.

In summary, the bird activity photographing system and method designed in the application can conveniently and effectively realize the panoramic photographing of bird activity, and the photographing effect thereof is superior, so as to facilitate the user or researcher to observe and record bird activity, which has a good promotion prospect and application value.

The above-mentioned description is only an example of the application, and is not intended to limit the scope of the application, and all equivalent transformation performed by using the contents of the specification and the drawings of the application or directly or indirectly applied to the related technical fields are included in the scope of the application.

1. A bird activity photographing system, comprising: a bird activity mechanism and a plurality of cameras; wherein the bird activity mechanism is used for birds to perform bird activity, the bird activity mechanism may specifically be at least one of a bird grain feeder, a hummingbird food feeder, a bird bath, or a bird stand rack; the plurality of the cameras are provided next to or opposite to each other to respectively photograph bird activity images of a preset range, the plurality of the cameras capture 360-degree photographing of bird activity in at least one dimension to acquire a 360-degree bird activity image.

2. The bird activity photographing system according to claim 1, wherein the number of the cameras is one, the camera rotates by a preset angle range around its own position and performs 360-degree photographing of bird activity in at least one dimension.

3. The bird activity photographing system according to claim 1, wherein the number of the cameras is one, the camera is provided at a top end or a bottom end of the bird activity mechanism and photographs upward or downward in a vertical direction to perform 360-degree photographing of bird activity in at least one dimension.

4. (canceled)

5. The bird activity photographing system according to claim 1, wherein the bird activity images photographed by the plurality of the cameras are cut and spliced to form the 360-degree bird activity image.

6. The bird activity photographing system according to claim 1, wherein the cameras are two and each is a fish-eye camera, and the two fish-eye cameras are provided back to back.

7. The bird activity photographing system according to claim 1, wherein the number of the cameras is at least three, and three of the cameras are provided next to or opposite to each other in the same dimension.

8. The bird activity photographing system according to claim 1, wherein the plurality of cameras are fixedly provided if the plurality of cameras are fixedly provided and in the sum of the preset ranges for photographing, 360-degree photographing in at least one dimension can be performed; if the plurality of cameras are fixedly provided and cannot perform 360-degree photographing in at least one dimension, at least one of the cameras needs to rotate a preset angle around its own position to complete the photographing.

9. (canceled)

10. The bird activity photographing system according to claim 1, wherein the bird grain feeder comprises: a feeding plate and a grain feeding body; the feeding plate is provided at a lower end of the grain feeding body, a through grain bin is provided inside the grain feeding body, and a lower end of the grain bin is a grain discharging end and is in communication with the feeding plate; wherein the camera is provided on the grain feeding body, and the feeding plate is photographed from inside to outside; alternatively, the camera is provided outside the feeding plate, and the feeding plate is photographed from outside to inside.

11. The bird activity photographing system according to claim 1, wherein the bird grain feeder comprises: a feeding plate and a grain feeding body; the grain feeding body is provided below the feeding plate, a through grain bin is provided inside the grain feeding body, and an upper end of the grain bin is a grain discharging end and is in communication with the feeding plate; wherein the camera is provided at the top of the feeding plate, and the direction of the feeding plate is photographed from inside to outside; alternatively, the camera is provided at the periphery of the feeding plate, and the direction of the feeding plate is photographed from outside to inside.

12. The bird activity photographing system according to claim 1, wherein the bird grain feeder comprises: a feeding plate and a grain feeding body;
the feeding plate is provided at a lower end of the grain feeding body, and the camera is provided on the grain feeding body or above the feeding plate, and the feeding plate is photographed from inside to outside.

13. The bird activity photographing system according to claim 1, wherein the hummingbird food feeder comprises: a sucking component and a hummingbird feeding body; the lower end of the hummingbird feeding body is connected to the sucking component, at least one sucking port is provided on the sucking component, and the camera is provided on the hummingbird feeding body or on the top of the sucking component.

14. The bird activity photographing system according to claim 1, wherein the hummingbird food feeder comprises: a hummingbird feeding body, at least one extension component and at least one sucking component, wherein one end of the extension component is connected to the hummingbird feeding body and the other end of the extension component is connected to the sucking component, and the sucking component is extended to the periphery of the hummingbird feeding body, and
the sucking component is located at or above the top of the hummingbird feeding body, and the camera is provided on the top of the hummingbird feeding body;
alternatively, the sucking component is located in the middle of the hummingbird feeding body, and the camera is provided on the periphery surface of the hummingbird feeding body;
alternatively, the sucking component is located at or below the bottom of the hummingbird feeding body, and the camera is provided at the periphery surface of the hummingbird feeding body.

15. The bird activity photographing system according to claim 1, wherein the bird bath comprises: a bath body; wherein the camera is provided on the top of the bath body, or above, or on the periphery of the bath body.

16. The bird activity photographing system according to claim 1, wherein the bird stand rack comprises: a main support and a secondary support rod, the main support extending in a first direction and the secondary support rod extending in a second direction, one end of the secondary support rod being connected to the main support; wherein the camera is provided on at least one of the main support or the secondary support rod.

17. The bird activity photographing system according to claim 16, wherein the camera is provided at an outer periphery of the main support to photograph from inside to outside; alternatively, the camera is provided at the other end of the secondary support rod or at the outer periphery of the secondary support rod to photograph from outside to inside.

18. The bird activity photographing system according to claim 16, further comprising a rotating rod and a surround photographing camera; the surround photographing camera is provided at one end of the rotating rod, and the other end of the rotating rod is rotatably connected to the main support and rotates about the main support as a rotating shaft.

19. The bird activity photographing system according to claim 16, wherein at least one close-up camera is provided on the main support, and the close-up camera is rotatably provided on the main support and rotates about the main support as a rotating shaft.

20. The bird activity photographing system according to claim 18, wherein the bird stand rack further comprises a lifting assembly that lifts and lowers at least one of the camera, the surround photographing camera along the first direction.

21. The bird activity photographing system according to claim 19, wherein the bird stand rack further comprises a lifting assembly that lifts and lowers at least one of the camera, the close-up camera along the first direction.

22. A bird activity photographing method applied to the bird activity photographing system according to claim 1, comprising the steps of:
S1: providing a plurality of cameras for photographing bird activity on a bird activity mechanism;
S2: using the plurality of the cameras to respectively photograph bird activity images within a preset range, and performing 360-degree photographing of bird activity in at least one dimension using the plurality of the cameras to acquire a 360-degree bird activity image.
